(19) United States
(12) Patent Application Publication
(10) Pub. No.: US 2004/0071626 A1
(43) Pub. Date: Apr. 15, 2004

(54) Reactor and method to produce a wide range of carbon blacks

(76) Inventors: Thomas Dale Smith, Kennesaw, GA (US); Alan Charles Berg, Acworth, GA (US); Luciano Di Feliciantonio, Kennesaw, GA (US)

Correspondence Address: NEEDLE & ROSENBERG, P.C., SUITE 1000, 999 PEACHTREE STREET, ATLANTA, GA, 30309-3915, US

(21) Appl. No.: 10/267,960

(22) Filed: Oct. 9, 2002

(51) Int. Cl. B01J 10/00

(52) U.S. Cl. 423/450; 422/150; 422/198; 422/151; 422/152

(57) ABSTRACT

A reactor for producing carbon black comprising, in the following order from upstream to downstream, a) a combination combustion/reaction section, wherein the combustion/reaction section comprises at least one inlet for introducing a combustion feed and at least one inlet for introducing a carbonaceous feedstock, b) a choke section, wherein the choke section comprises at least one inlet for introducing a carbonaceous feedstock and wherein the choke section converges to a downstream end, c) a quench section, wherein the cross section of the quench section is equal to or larger than the downstream end of the choke section and smaller than the cross section of the combustion/reaction section, and d) a breeching section. Also disclosed is a method for producing carbon black. Further disclosed is a simplified carbon black plant for producing tread and/or carcass type carbon black.

### BACKGROUND OF THE INVENTION

1. Field of the Invention

This invention relates generally to an apparatus and method for production of carbon black.

2. Background

Various methods for production of carbon black are known in the art. Generally, production of carbon black is performed in a reactor by partial combustion and/or pyrolytic conversion of hydrocarbons. In this conventional reactor process for manufacturing carbon black, a hydrocarbon fluid fuel, commonly natural gas or fuel oil, is burned in a stream of process air furnished by a blower. The hot gases produced by the combustion of the fuel flow through a vessel, usually lined with refractory, and ordinarily of circular cross section. A feedstock oil, usually highly aromatic, which serves as the chief source of carbon in the system, is injected into the flowing hot gases downstream of a point where the combustion of the fuel is complete. The oil feedstock must be vaporized as one step in the carbon black forming process in order for the process to be successful. Vaporization is favored by high velocity of the hot gas stream, a high degree of turbulence, high temperature, and high degree of atomization of the oil.

The feedstock oil vapor is carried by the hot combustion gases, the combustion gases attaining temperatures of from about 2400° F. to about 3400° F., varying with the methods used for controlling combustion. Radiant heat from the refractory, heat directly transmitted by the hot gases, high shear and mixing in the hot gases, and combustion of a portion of the oil by residual oxygen in the combustion products all combine to transfer heat very rapidly to the feedstock oil vapors. Under these conditions, the oil feedstock molecules are cracked, polymerized and dehydrogenated, and progressively become larger and less hydrogenated until some reach a state such that they may be called nuclei of carbon. The nuclei grow in size, and at some stage there is coalescence of particles to form cluster-like aggregates, known as “structure”. At the completion of the process, the hot gases containing the carbon black are quenched to a temperature low enough to stop or significantly slow the reactions, and to allow the carbon black to be collected by conventional means.

A broad variety of carbon blacks has been disclosed in the art. These carbon blacks differ in many properties from each other and are made by different processes. The main field of use of the blacks depends upon their properties. Since the carbon black, as such, cannot be sufficiently characterized by its chemical composition or by its ingredients, it has become widely accepted to characterize the carbon black by the properties it exhibits. Thus, the carbon black can, for example, be characterized by its surface area.

Carbon black is well known as a reinforcing agent for rubber to be used, for example, in compounds for the construction of tires. There are two general categories of carbon black used in the automotive tire industry. Certain types of carbon black are best used as reinforcing agents for tire tread compounds, and other types of carbon black are best used for reinforcing agents in tire carcasses—the so-called “soft” blacks, such as those used in tire carcasses; and the “hard” blacks which impart high abrasion resistance to rubber used in tire treads, commonly known in the trade as “tread blacks”. Generally speaking, it is desirable to use carbon blacks in the ASTM 100-300 series for tire treads (e.g., surface areas of from about 60 to about 150 m²/g, or even more) and in the ASTM 400-700 series for carcasses (e.g., surface area of about 25 to about 70 m²/g, such as 30 or 40 m²/g). The tread blacks are much finer than the carcass blacks, that is, the particles are much smaller. The properties of the various carbon blacks within the series can have a large influence on the properties of the desired rubber product into which the carbon black has been compounded.

Tread type carbon blacks are usually produced by using a different process and reactor than that used for the production of carcass type carbon blacks. Tread blacks are small particle size. This requires a fast, hot reactor, i.e., higher velocity and temperature. Residence times for these processes are in the milliseconds order of magnitude. Tread blacks are made at higher velocities and lower ratios of oil to flowing gases than the carcass blacks.

Carcass type blacks comprise larger particles. In order for the particles to become large, the reaction is slow and done in a relatively low temperature reactor. Residence times are in the seconds order of magnitude. These carbon blacks are made at low velocities and high ratios of oil to flowing gases.

The necessity of having different reactors for different products is burdensome for carbon black plants and the desirability of having a single reactor which could produce both types of carbon blacks is readily apparent.

It is desirable to have a single reactor rather than different reactors to produce both types of carbon black for operational flexibility (to better meet production/market product requirements), fewer mechanical components to install (capital) and maintain, and reduced spatial requirements.

A single reactor design for both types of blacks has been accomplished previously in the following ways.

In U.S. Pat. No. 4,822,588 (U.S. Pat. No. '588) by Gravley et al., issued Apr. 18, 1989, (and divisional patent U.S. Pat. No. 4,824,643 (U.S. Pat. No. '643)), a carbon black reactor is disclosed which is characterized by a converging zone, a throat, a first reaction zone, and a second reaction zone serially connected (see FIG. 4). The reactor has a reaction flow passage having a longitudinal axis. The combustion zone and a reactor throat are positioned along the longitudinal axis of the reactor, and a converging zone converges from the combustion zone to the reactor throat. A quench zone is spaced apart from the reactor throat and has a cross sectional dimension of at least 3 times the cross sectional dimension of the reactor throat. A reaction zone connects the reactor throat with the quench zone. The reaction zone has a cross sectional dimension less than that of the quench zone and in the range of 1.2 to 3 throat diameters. The reaction zone has a length in the range of from 2 to 6 throat diameters. A burner is operably associated with the combustion zone to cause axial flow of hot combustion gases from the combustion zone to quench zone. At least one port for receiving an oil injector for introducing a carbonaceous feedstock radially inwardly toward the longitudinal axis of the reaction flow passage is provided in the reaction zone. The reactor is further provided with a means for introducing quench fluid into the quench zone. By providing oil injectors in the ports of both sides of the reactor throat, carbon black can be produced at high efficiencies, especially soft carbon black, although both hard and soft carbon blacks can be produced by positioning injectors in either the converging or reaction zones. By providing ports both upstream and downstream of the throat, the reactor is set up to produce hard or soft blacks. The patents disclose a process for producing carbon black in a reaction flow passage having an upstream end, a converging zone, a reactor throat, a reaction zone, a quench zone, and a downstream end, said process comprising:

(a) combusting a hydrocarbon fuel with excess amounts of oxygen-containing gas to form a mass of hot combustion gases containing free oxygen and flowing generally axially from the upstream end toward the downstream end of the reaction flow passage;

(b) flowing the mass of hot combustion gases through the converging zone;

(c) introducing a carbonaceous feedstock generally radially inwardly into the hot combustion gases at a position from the periphery of the converging zone to form a first reaction mixture;

(d) flowing the first reaction mixture through the reactor throat, wherein the reactor throat has a radius and a diameter of two times the radius, past a first abrupt expansion in the reaction flow passage at a downstream end of the reactor throat, and into an upstream end of the reaction zone, said first abrupt expansion connecting the reactor throat with the reaction zone;

(e) introducing additional carbonaceous feedstock generally radially inwardly into the reaction mixture at a position from the periphery of the reaction zone to form a second reaction mixture; and

(f) flowing the second reaction mixture past a second abrupt expansion in the reaction flow passage at a downstream end of the reaction zone and into a quench zone having a sufficiently large diameter and length to provide for the formation of carbon black.

This reactor has feedstock oil sprays located only downstream of the combustion zone of the reactor. The feedstock injectors are in the converging zone and in the reaction zone.

Canadian Patent 811,653, Dollinger, issued Apr. 29, 1969, discloses a process for producing carbon black (see FIG. 5). The process uses variations in reactor pressure to produce tread and carcass type carbon blacks. The surface area of the carbon black produced is 25-150 m²/g. Carcass black is produced at 3 atmospheres and tread black at 1 atmosphere. Reactor pressure is increased to decrease carbon black surface area, and fluid rate is increased to maintain a photelometer value of about 90. Pressure is decreased to increase surface area, and fluid rate is decreased to maintain the 90 photelometer value. A surface area of about 140 m²/g is achieved at atmospheric pressure and about 40 m²/g at 3 atm. The ratio of reactant fluid rate to oxygen-containing gas increased about 80% to maintain photelometer value.

The reactant feed (carbonaceous feedstock) flows to the precombustion chamber (where air or air/fuel enters). This then flows to the reactor section. From the reactor section, the flow is to the quench section, where there is a backpressure valve for adjusting pressure. The flow then proceeds to a recovery/separator.

U.S. Pat. No. 4,904,454, Schaefer et al., issued Feb. 27, 1990, (and divisional U.S. Pat. No. 4,970,059) discloses a tubular furnace as a reactor for producing carbon black (see FIG. 6). The reactor has a constriction in at least the area of the spray device for the carbon black starting material which is oriented along the reactor axis. The combustion chamber for generating gaseous pyrolysis medium for the carbon black raw material is laterally located in front of the constriction (at a right angle to the reaction section). The feedstock is injected at the reaction section/restriction element.

The current invention accomplishes a single reactor design in a different way. Examples of advantages over other single reactor designs are greater colloidal range, reduced operating/capital costs, and greater flexibility.

### SUMMARY OF THE INVENTION

The present invention relates to an apparatus and method for producing multiple types of carbon black from a single reactor, for example, tread and/or carcass type carbon blacks.

In accordance with this invention, as embodied and broadly described herein, this invention relates to an apparatus. The apparatus comprises 4 sections or “zones”. The apparatus can be a reactor for producing carbon black comprising, in open communication and in the following order from upstream to downstream,

a) a combination combustion/reaction section, wherein the combustion/reaction section comprises at least one inlet for introducing a combustion feed therein and at least one inlet for introducing a carbonaceous feedstock therein;

b) a choke section, wherein the choke section comprises at least one inlet, separate from the combustion/reaction section inlets, for introducing a carbonaceous feedstock therein and wherein the choke section converges toward a downstream end;

c) a quench section, wherein the quench section comprises at least one inlet, separate from the combustion/reaction section and choke section inlets, for introducing a quench material therein; and

d) a breeching section.

The invention can also be a system for producing tread and/or carcass type carbon black comprising

a) a combination tread/carcass carbon black reactor upstream of and in communication with

b) a heat exchanger upstream of and in communication with

c) a carbon black beading system.

This invention also relates to a method. The method can be a method for producing tread and/or carcass type carbon black in a single reactor comprising

a) providing a reactor comprising, in open communication and in the following order from upstream to downstream,

i) a combination combustion/reaction section, wherein the combustion/reaction section comprises at least one inlet for introducing a combustion feed therein and at least one inlet for introducing a carbonaceous feedstock therein,

ii) a choke section, wherein the choke section comprises at least one inlet, separate from the combustion/reaction section inlets, for introducing a carbonaceous feedstock therein and wherein the choke section converges toward a downstream end,

iii) a quench section, wherein the quench section comprises at least one inlet, separate from the combustion/reaction section and choke section inlets, for introducing a quench material therein, and

iv) a breeching section;

b) combusting fuel and an oxidant in the combustion/reaction section to form a stream of combustion gas flowing downstream through the reactor;

c) introducing a carbonaceous feedstock into the reactor; and

d) maintaining process conditions in the reactor to convert the feedstock to carbon black with desired characteristics,

wherein the carbonaceous feedstock is introduced into the combustion/reaction section of the reactor when producing a carcass type carbon black product, and

wherein the carbonaceous feedstock is introduced into the choke section of the reactor when producing a tread type carbon black product.

The invention can also be a method for producing tread and/or carcass type carbon black ready for packaging or distribution or use comprising

a) introducing fuel, oxidant, and a carbonaceous feedstock into a combination tread/carcass reactor to produce a carbon black product,

b) passing the carbon black product and any combustion and/or reaction gas through a heat exchanger to cool the product and gas,

c) introducing the cooled product and cooled combustion and/or reaction gas to a primary collection system,

d) disposing of or treating the cooled combustion/reaction gas,

e) feeding the collected product from the primary collection system to a beading system,

f) moving the beaded product to a product screen to sort the product by size, and

g) allowing the sorted product to flow to a storage area.

Additional advantages of the invention will be set forth in part in the description which follows, and in part will be apparent from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings are incorporated in and constitute a part of this specification. The drawings together with the description, serve to explain the principles of the invention.

FIG. 1 shows a schematic of a “typical” prior art tread type reactor.

FIG. 2 shows a schematic of a “typical” prior art carcass type reactor.

FIG. 3 shows another schematic of a “typical” prior art carcass type reactor.

FIG. 4 shows the U.S. Pat. No. 4,822,588 Gravley et al. carbon black reactor.

FIG. 5 shows the CA 811,653 Dollinger carbon black reactor.

FIG. 6 shows the U.S. Pat. No. 4,904,454 Schaefer et al. carbon black reactor.

FIG. 7 shows a schematic of an embodiment of a carbon black reactor of the current invention.

FIG. 8 shows a schematic of an embodiment of a simplified plant system for producing carbon black of the present invention.

FIG. 9 shows a schematic of a conventional plant system for producing carbon black.

### DETAILED DESCRIPTION OF THE PREFERRED EMBODIMENTS

Before the present compounds, compositions, articles, devices, and/or methods are disclosed and described, it is to be understood that this invention is not limited to specific methods of making the apparatus, these methods may, of course, vary. It is also to be understood that the terminology used herein is for the purpose of describing particular embodiments only and is not intended to be limiting.

### Definitions

It must be noted that, as used in the specification and the appended claims, the singular forms “a,” “an” and “the” include plural referents unless the context clearly dictates otherwise. Thus, for example, reference to “an oxidant” includes mixtures of oxidants, reference to “a fuel” includes mixtures of two or more such fuels, and the like.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

In this specification and in the claims which follow, reference will be made to a number of terms which shall be defined to have the following meanings:

“Optional” or “optionally” means that the subsequently described event or circumstance may or may not occur, and that the description includes instances where said event or circumstance occurs and instances where it does not.

By the term “effective” describing a property or parameter (such as velocity or residence time) as provided herein is meant such property or parameter as is capable of performing the function of the section, property or parameter for which an effective property or parameter is expressed. As will be pointed out below, the exact design condition will vary from process to process, depending on recognized variables such as the compositions employed and the processing conditions observed. Thus, it is not possible to specify an exact “effective” property or parameter. However, an appropriate effective property or parameter may be determined by one of ordinary skill in the art using only routine design procedures and/or experimentation.

“Zone” and “section” are used virtually synonymously/interchangeably throughout this application.

### Description

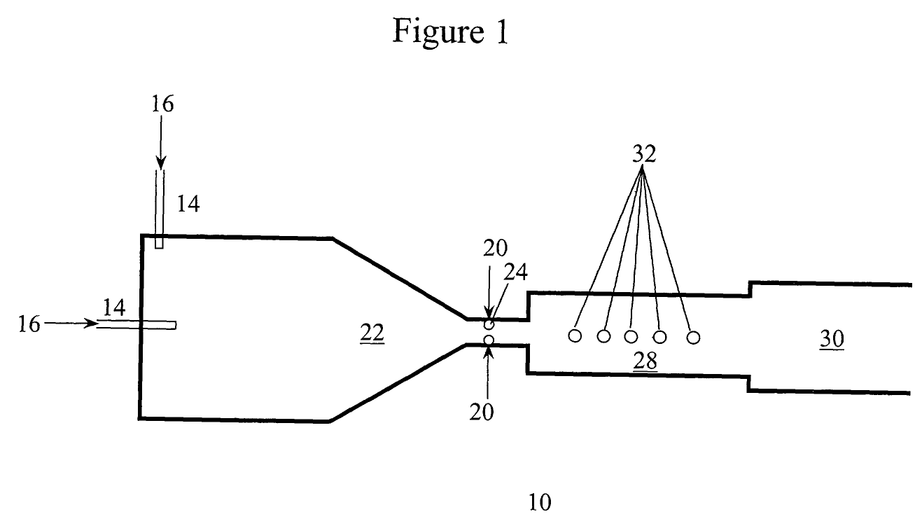

A “typical” or conventional tread type reactor (as known in the art and generally schematically illustrated in FIG. 1) has separate combustion and reaction sections and produces products at flow velocities of about 1000 to about 1800 feet per second (fps), temperatures of about 2700 to about 3800° F., and residence times of about 4 to about 200 ms.

The present reactor differs from a FIG. 1 reactor, for example, in that the present reactor adds the carbonaceous feedstock in the first combination combustion/reaction section and/or the converging choke section whereas the carbonaceous feedstock is added to the FIG. 1 type reactor at a smaller diameter section between the combustion section and the quench section.

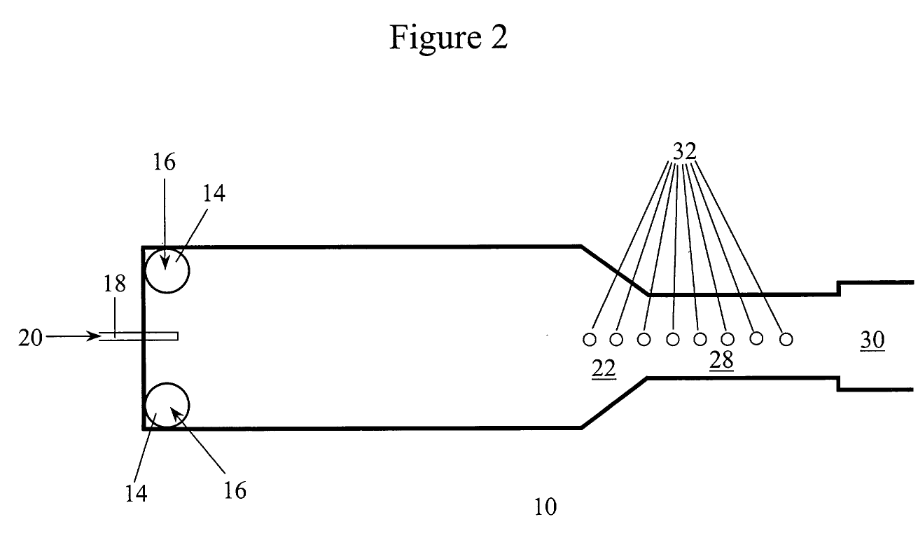

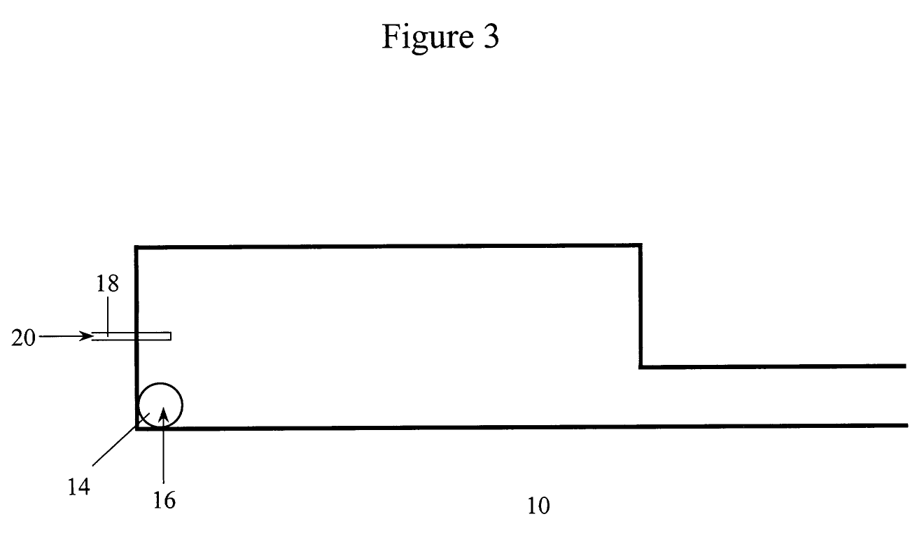

In a “typical” or conventional carcass type reactor (as known in the art and generally schematically illustrated in FIGS. 2 and 3) product is produced at flow velocities of about 20 to about 500 fps, temperatures of about 2000 to about 3200° F., and residence times of about 0.5 to about 2 seconds. Combustion of a fuel in addition to feedstock is not always required to provide energy for converting the feedstock in a “typical” carcass type reactor, i.e., in some cases the fuel can be the feedstock without need for addition of another carbonaceous material. A separate combustion zone is not required; combustion of fuel may occur, e.g., externally to the primary reactor.

The present reactor differs from a FIG. 2 reactor, for example, in that the present reactor adds the carbonaceous feedstock in the first combination combustion/reaction section and/or the converging choke section whereas the carbonaceous feedstock is added to the FIG. 2 type reactor at the upstream end of the reaction/combustion section.

The present reactor differs from a FIG. 3 reactor, for example, in that the present reactor adds the carbonaceous feedstock in the first combination combustion/reaction section and/or the converging choke section whereas the FIG. 3 reactor has a long reaction section which leads into a smaller diameter inlet to a diverging section, which leads to an intermediate diameter reaction section. The carbonaceous feedstock is added to a FIG. 3 type reactor at the beginning of the long reaction section.

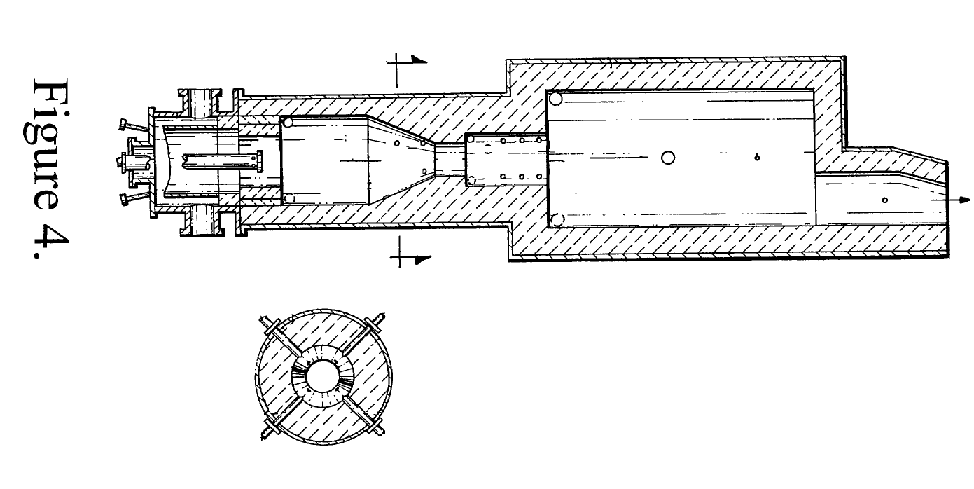

The present reactor differs from U.S. Pat. No. '588 and U.S. Pat. No. '643 (FIG. 4), for example, in that the present reactor adds the carbonaceous feedstock in the first combination combustion/reaction section and/or the converging choke section. The '588/'643 patents add the carbonaceous feedstock in the converging zone and reaction zone which are both downstream of the combustion zone.

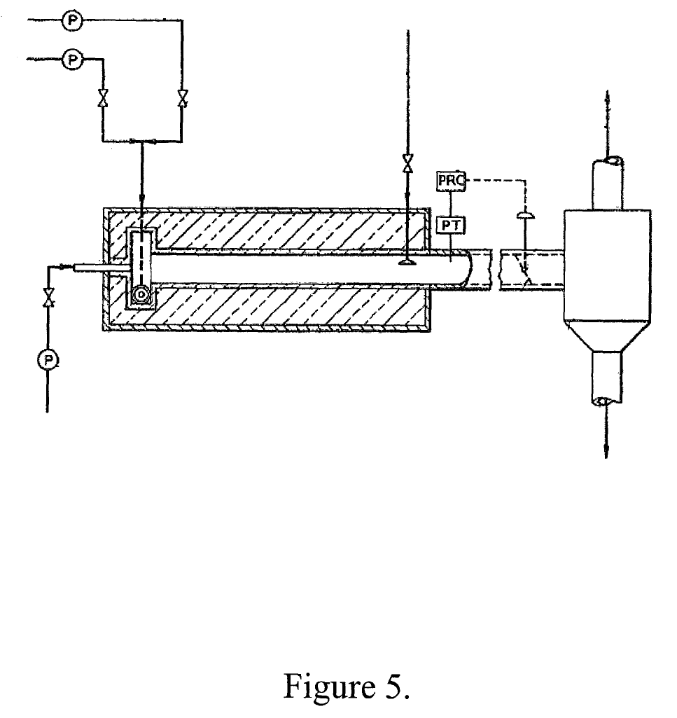

The present reactor differs from the CA 811,653 Dollinger patent (FIG. 5), for example, in that the present reactor adds the carbonaceous feedstock in the first combination combustion/reaction section and/or the converging choke section whereas the Dollinger '653 patent adds the carbonaceous feedstock only upstream at the pre-combustion chamber. The point of novelty for the Dollinger '653 reactor is the control of product characteristics by creating back pressure.

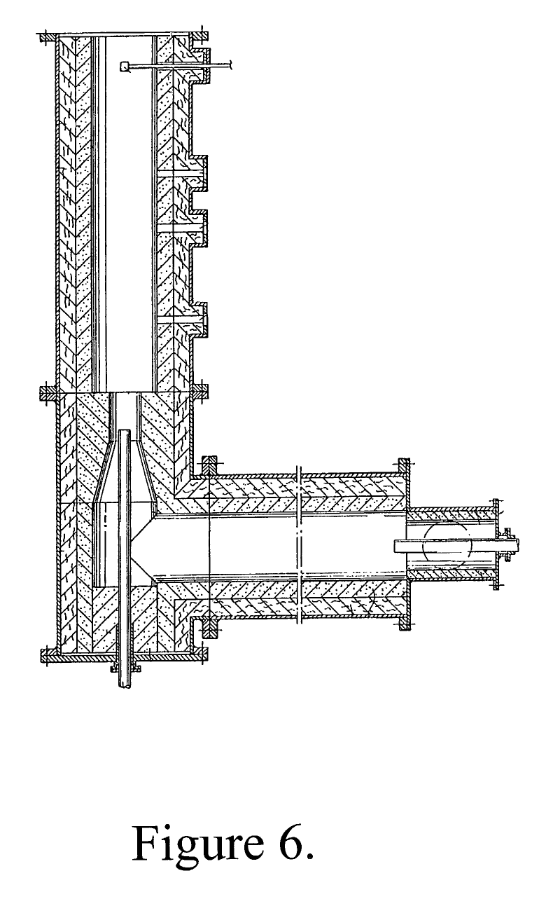

The present reactor differs from the U.S. Pat. No. 4,904,454 Schaefer et al. (FIG. 6) and U.S. Pat. No. 4,970,059 Schaefer et al. patents, for example, in that the present reactor adds the carbonaceous feedstock in the first combination combustion/reaction section and/or the converging choke section, whereas the Schaefer '454/'059 patents add the carbonaceous feedstock only at its constriction element, and the combustion gases must enter perpendicularly to the first zone of its reaction section.

The present combination reactor concept was born of a desire to develop a low capital cost plant design with reduced process complexity.

Many carbon black reactor designs exist, including modular designs wherein the change of a section or spool piece facilitates conversion from tread to carcass type rubber carbon black production. A few designs exist in which a single mechanical configuration is used to produce both tread and carcass type carbon blacks, but a better, more flexible design was still desired.

It was conceived to produce an apparatus and method which permitted production of both tread and/or carcass carbon blacks in a single apparatus configuration by movement of the feedstock injection entry points and varying other operating parameters known to those of skill in the art.

The present reactor is a single device which allows the production of tread and carcass type carbon blacks without interruption. The reactor allows a quick changeover from tread to carcass type black. The reactor comprises a combination combustion/reaction section that provides the desirable reaction volume for carcass carbon black types and combustion volume for tread carbon black types. The second section of the reactor, downstream of the combustion/reaction section, comprises a converging choke for higher velocities and tread carbonaceous feedstock injection. Downstream of the choke section is the quench section of the reactor, which provides control for the desirable reaction time for the products being produced. The breeching section, downstream of the quench section, is designed to provide high enough velocities to transport the carbon black out of the device as well as sufficient residence times for efficient quench water droplet vaporization prior to the process stream entering a downstream process or apparatus, e.g., a process air heat exchanger.

### Apparatus

Referring now to the drawings, in which like reference numerals indicate like parts throughout the several views, an embodiment of an apparatus of the invention is discussed.

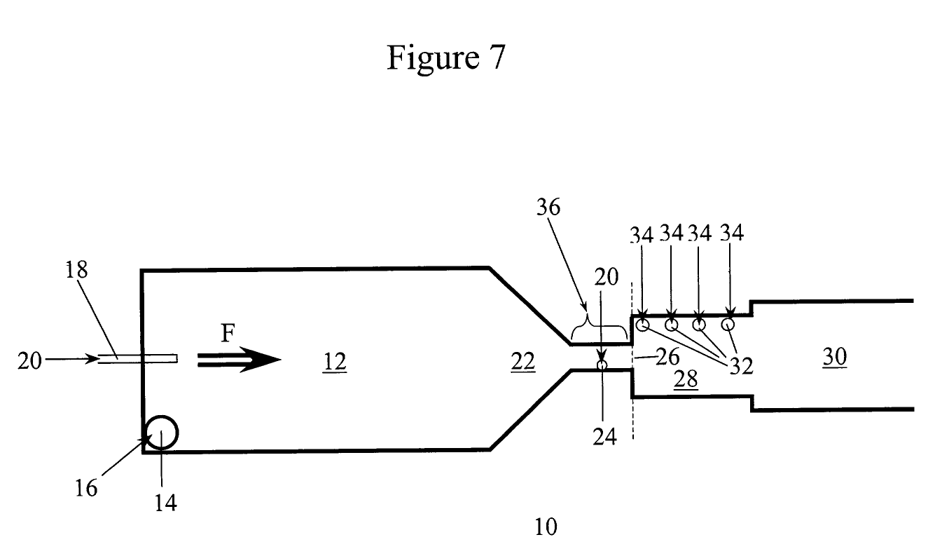

A reactor 10 for producing carbon black is shown and described herein. One embodiment of the apparatus of the invention is illustrated schematically in FIG. 7. The reactor 10 for producing carbon black comprises, in open communication and in the following order from upstream to downstream,

a) a combination combustion/reaction section 12, wherein the combustion/reaction section 12 comprises at least one inlet 14 for introducing a combustion feed 16 therein and at least one inlet 18 for introducing a carbonaceous feedstock 20 therein,

b) a choke section 22, wherein the choke section 22 comprises at least one inlet 24, separate from the combustion/reaction section inlets 14, 18, for introducing a carbonaceous feedstock 20 therein and wherein the choke section 22 converges toward a downstream end 26,

c) a quench section 28, wherein the quench section 28 comprises at least one inlet 32, separate from the combustion/reaction section 14, 18 and choke section 24 inlets, for introducing a quench material 34 therein, and

d) a breaching section 30.

The arrow, F, indicates a general process flow direction (upstream to downstream.

The following descriptions describe at least one embodiment of each section of the apparatus.

### Combustion/Reaction Section

The combination combustion/reaction (C/R) section 12 is the first section of the apparatus 10. This section 12 serves as the location for combustion and reaction when producing carcass type blacks. The carbonaceous feedstock 20 is injected into this section 12 when producing carcass type carbon black. The C/R section 12 serves as the combustion area when producing tread type carbon blacks.

The geometry of the combination C/R section 12 is any which will physically support the section and be conducive to the purposes of the section. The section 12 can be essentially cylindrical, and, generally, a pipe or cylindrical shape is the geometry that will be used in practice. The dimensions are designed such that the desired residence time, velocity, temperature, and uniformity of flowing gases are achieved. The cross sectional area is designed to produce the desired velocities. The length is designed for the desired residence time. One specific example of dimensions for this section 12 is an about 20′ length and an about 30″ inner diameter. One of skill in the art would be able to determine the specific geometry and dimensions appropriate for the flow rates, residence times, etc. desired in a particular embodiment according to standard design processes. Such a standard design process includes using a “design case” to determine residence time, pressure drop, etc.

The C/R section 12 comprises a material which can withstand the temperatures reached by the combustion and reaction occurring in the section 12. This temperature can be up to about 3800° F. This material can comprise, for example, a refractory material or a metallic material, such as high alumina hot face refractory. The section 12 can comprise layers of various materials. One of skill in the art would be able to determine the types of material appropriate for the conditions expected within the C/R section 12 of the reactor 10 according to factors such as process, economic, and safety considerations.

The C/R section 12 has at least one inlet 14 for introducing a combustion feed 16 therein and at least one inlet 18 for introducing a carbonaceous feedstock 20 therein.

The at least one inlet 14 for introducing a combustion feed 16 therein is any geometry and size which will adequately serve as an inlet point to the C/R section 12 for a combustion feed 16. One of skill in the art would be able to determine an adequate size and geometry for the inlet 14. The inlet 14 can be, for example, circular in cross section. The at least one inlet 14 can be multiple inlets, e.g., one inlet 14 for fuel 16 and one inlet 14 for an oxidant 16 or multiple inlets 14 that are used for introduction of both fuel 16 and oxidant 16. The at least one inlet 14 can deliver a combustion feed 16 that is “pre-combusted” fuel 16 and oxidant 16.

The combustion feed 16 can comprise a fuel. The combustion feed 16 can further comprise an oxidant or, alternatively, comprise only an oxidant (e.g., in the case where the feedstock can be combusted with an oxidant for heat energy input as well as the feedstock being reacted to form carbon black). The fuel 16 can comprise any material that will provide the necessary heat energy for converting the carbonaceous feedstock 20 to carbon black. Examples of fuel 16 are hydrocarbons such as natural gas, methane, propane, fuel oil, slurry oil (or decant oil) from fluid catalytic cracker (FCC) operation, ethylene tar, coal tar, carbon monoxide-containing gas, hydrogen-containing gas, or other combustible gas mixture. The oxidant 16 can comprise any material that will allow the fuel 16 to combust or otherwise release its heat energy to “power” the carbon black conversion reaction. Examples of oxidants 16 are air or oxygen. The choices of fuel 16 and oxidant 16 can be determined by one of skill in the art according to chemical and engineering considerations.

The at least one inlet 18 for introducing a carbonaceous feedstock 20 into the C/R section 12 is any geometry and size which will adequately serve as an inlet point to the C/R section 12 for the carbonaceous feedstock 20. One of skill in the art would be able to determine an adequate size and geometry for the inlet 18. The inlet 18 can be, for example, circular in cross section. The at least one inlet 18 can be multiple inlets, e.g., multiple inlets at various locations within the C/R section 12 which delivers carbonaceous feedstock 20.

The carbonaceous feedstock 20 can comprise any carbon-containing material that will react to form carbon black. Examples of carbonaceous feedstock 20 include oil, slurry oil from FCC operation, ethylene tar, coal tar, or any other highly carbonaceous hydrocarbon.

The combustion feed 16 and carbonaceous feedstock 20 can be introduced to the section at various locations and various angles. For example, the combustion feed 16 can be introduced radially, tangentially, or along the longitudinal axis of the section 12. The carbonaceous feedstock 20 can be introduced, for example, radially, tangentially, or along the longitudinal axis of the section 12.

The following is a description of one particular embodiment of the present invention.

In the C/R section 12 of the reactor 10, pre-heated process air 16 and fuel (e.g., natural gas) 16 can be introduced at multiple tangential entries 14 to the C/R section 12. Multiple swirls of air 16 and fuel 16 can be introduced into this section 12 which lead to complete and swift combustion.

During carcass type carbon black production, atomized carbonaceous feedstock (e.g., oil) 20 can be injected along the longitudinal axis through a central oil injection spray 18 into the combustion/reaction section 12.

The C/R section 12 is designed for effective residence time(s) and effective velocity(ies) to support carcass black production (reaction) for a design case (base design for reactor to meet desired production rates). Effective residence time and velocity are those which produce the right product, e.g., one with the desired colloidal, surface area, and structural properties (properties which affect end-use application properties of the carbon black). One of skill in the art is able to determine an effective residence time and an effective velocity using standard design procedures.

Velocities and residence times in this section 12 are “similar” to the conventional reactors, such as in FIGS. 1-3, e.g., for carcass carbon black about 40 to about 200% of “conventional” and for tread carbon blacks about 75 to about 140% of “conventional.”

During tread type carbon black production, the C/R section 12 serves as a combustion chamber to allow essentially complete and efficient combustion of fuel 16 with air 16 prior to feedstock 20 injection in the choke section 22. For example, greater than about 98% combustion can be expected. Excess oxidant 16 can be provided.

The combustion volume in the section 12 can provide substantially longer (e.g., about 3-5×) combustion residence times than a conventional tread reactor under design process conditions.

### Choke Section

The choke section 22, or converging choke section, is the second section of the apparatus 10. The choke section 22 is downstream of and in communication with the C/R section 12. The choke section 22 can abut and connect to the combination combustion/reaction section 12, for example, by flanges and bolts, to form a contiguous section for process flows.

The choke section 22 is where the carbonaceous feedstock 20 is injected for tread type carbon black production, thus serving as a reaction area for tread type carbon blacks.

The geometry of the choke section 22 is any which will physically support the section and be conducive to the purposes of the section 22. The upstream and downstream 26 ends of the section 22 can be essentially cylindrical. The upstream end of the choke section 22 can have a cross sectional area essentially equal to or smaller than, for example, that of the downstream end of the C/R section 12. The downstream end 26 of the choke section 22 can have a cross sectional area essentially equal to or less than, e.g., about 20 to about 50%, for example, that of the upstream end of the quench section 28. Other cross sectional areas can be used. The choke section 22 can be angled in cross section/diameter toward the quench section 28 or make a step change in cross section/diameter toward the quench section 28. The choke section 22 generally converges, or contracts, from its upstream end toward its downstream end 26. The section 22 can have, for example, a generally funnel-like shape. For example, this section 22 can have an about 10° to an about 90° approach angle. The throat section 36 cross sectional area can be designed to meet a velocity range for tread production of about 1000 to about 1800 feet per second. The dimensions are designed such that the desired residence time and velocity are achieved. The cross sectional area is designed to provide desired velocities. The length is designed to provide the desired throat velocity, operating conditions (such as pressure drop requirements), and material stability (minimize erosion and its impact) of the section 22. One specific example of dimensions for the section 22 is an about 30″ upstream end inner diameter, an about 9″ downstream end 26 inner diameter, an about 28″ length of the converging section, and an about 40″ overall length. One of skill in the art would be able to determine the specific geometry and dimensions appropriate for the flow rates, residence times, etc. desired in a particular embodiment according to standard design processes. Such a standard design process includes using a “design case” to determine residence time, pressure drop, etc.

The choke section 22 comprises a material which can withstand the temperatures reached by the combustion and/or reaction occurring in this section 22. This temperature can be up to about 3800° F. This material can comprise, for example, a refractory material or a metallic material, such as high alumina hot face refractory. The section 22 can comprise layers of various materials. One of skill in the art would be able to determine the types of material appropriate for the conditions expected within the choke section 22 of the reactor 10 according to process, economic, and safety considerations, for example.

The choke section 22 has at least one inlet 24 for introducing a carbonaceous feedstock 20 therein. The at least one inlet 24 for introducing a carbonaceous feedstock 20 is any geometry and size which will adequately serve as an inlet point to the choke section 22 for the carbonaceous feedstock 20. One of skill in the art would be able to determine an adequate size and geometry for the inlet 24. The inlet 24 can be, for example, circular in cross section. The at least one inlet 24 can be multiple inlets, e.g., multiple inlets at various locations within the choke section 22 which lets in carbonaceous feedstock 20.

The carbonaceous feedstock 20 can comprise any carbon-containing material that will react to form carbon black. Examples of carbonaceous feedstock 20 include oil, slurry oil from FCC operation, ethylene tar, coal tar, or any other highly carbonaceous hydrocarbon. The carbonaceous feedstock 20 can be the same as or different than the carbonaceous feedstock 20 fed to the C/R section 12.

The feedstock 20 can be introduced to the section 22 at various locations and various angles. The feedstock 20 can be introduced, for example, radially, tangentially, or along the longitudinal axis of the section 22.

During tread type carbon black production, atomized carbonaceous feedstock (e.g., oil) 20 can be injected into the choke section 22.

In carcass type carbon black production, the choke section 22 can be utilized as a transition section prior to the quench section 28 of the reactor 10.

The present reactor's choke section 22 is designed to act as a high velocity transition section to the quench section 28 and operate at higher velocities than conventional carcass reactors (e.g., about 1.5 to about 3 times higher velocity than a “normal” carcass reactor transition to quench section).

In one particular embodiment of the invention during tread type carbon black production, the choke section 22 is utilized to inject feedstock 20 into a high velocity (e.g., velocity transitions in converging portion so range of velocities in choke section is about 200 to about 1800 fps) combusted gas flow through multiple radial nozzles 24 around the circumference of the section 22.

If it is desired to make both carcass type and tread type carbon blacks, carbonaceous feedstock (e.g., oil) 20 can be injected into both the C/R section 12 and the choke section 22.

### Quench Section

The quench section 28 is the third section of the apparatus 10. The quench section 28 is downstream of and in communication with the choke section 22. The quench section 28 can abut and connect to the choke section 22, for example, by flanges and bolts, to form a contiguous section for process flows. The quench section 28 is the location designed for cooling of the process material streams (e.g., combustion gases, produced carbon black).

The geometry of the quench section 28 is any which will physically support the section and be conducive to the purposes of the section 28. The section 28 can be essentially cylindrical, and, generally, a pipe or cylindrical shape is the geometry that will be used in practice. The dimensions are designed such that the desired residence time, gas velocity (keep product suspended), and secondary water atomization (water droplet breakup due to shear forces between water droplet and gas stream) are achieved. The cross sectional area is designed to provide water across the cross section/diameter of the section 28, give the desired pressure drop, and give the desired velocity. The cross section/diameter of the quench section 28 can be about 1.2 to about 2 times the cross section/diameter of the downstream end of the choke 26. The length is designed for residence times which essentially stop the carbon black reaction. The distances between the sprays 32 are designed to provide the desired residence times for various types of carbon black. The quench section 28 is essentially designed for tread carbon black since carcass reactions are generally complete by the time they reach this section 28. One specific example of dimensions of the section 28 is an about 15″ inner diameter and an about 16′ length. An example of reaction times (from choke outlet 26 to the quench spray position 32) for tread can be up to about 200 milliseconds. One of skill in the art would be able to determine the specific geometry and dimensions appropriate for the flow rates, residence times, etc. desired in a particular embodiment according to standard design processes. Such a standard design process includes using a “design case” to determine residence time, pressure drop, etc.

The quench section 28 comprises a material which can withstand the temperatures reached by the combustion gases and reaction. This temperature can be up to about 3800° F., but will generally be significantly lower as cooling takes place in this section 28. This material can comprise a refractory material or a metallic material, such as high alumina hot face refractory. The section 28 can comprise layers of various materials. One of skill in the art would be able to determine the types of material appropriate for the conditions expected within the quench section 28 of the reactor 10 according to process, economic, and safety considerations, for example.

The quench section 28 can have at least one inlet 32 for introducing a quench material 34, e.g., a liquid, such as water therein. The purpose of the section 28 is to bring the temperature of the process materials to a low enough temperature at which the carbon black conversion reaction will essentially stop.

The at least one inlet 32 for introducing quench material 34 is any geometry and size which will adequately serve as an inlet point to the quench section 28 for the quench material 34. One of skill in the art would be able to determine an adequate size and geometry for the inlet 32. The at least one inlet 32 can be circular in cross section, for example. The inlet 32 can be multiple inlets, e.g., multiple inlets at various locations within the quench section 28 which let in quench material 34.

The quench material 34 can comprise any material that will dissipate the heat energy of the reaction (cool the process streams) to a desired temperature (for example, that temperature at which the reaction will essentially stop) without adverse effects to the reactor 10 or end product, carbon black. Examples of quench material 34 include water, steam atomized water, and filtered process gases. The choice of quench material 34 can be determined by one of skill in the art according to chemical and engineering considerations.

The quench material 34 can be introduced to the section 28 at various locations and various angles. For example, the quench material 34 can be introduced radially, tangentially, or along the longitudinal axis of the section 28.

The quench section 28 is used to control overall reaction times of the tread and/or carcass type carbon blacks being produced. This is accomplished by lowering the temperature of the process streams until the reaction essentially stops at a desired location along the length of the section 28. Further cooling, in addition to the cooling necessary to quench the reaction, can be done by addition of, for example, the same quench material 34 to reduce the temperature of the process stream to meet inlet temperature requirements for the downstream process equipment (e.g., heat exchanger equipment).

Multiple quench locations allow different tread and carcass type black qualities to be optimized. Multiple positions along the reactor 10 or process flow F give choices of longer residence/reaction times which contribute to certain attributes, e.g., surface activity, of the carbon black. Spacing of positions 32 can be, for example, for reaction time increments of about 5 to about 20 milliseconds.

Reaction times and velocities in the quench section 28 are “similar” to the reaction times and velocities in the quench section of conventional reactors. For example, the reaction times can be about 80 to about 150% of conventional tread reaction times, and the velocities can be about 50 to about 150% of conventional tread velocities.

### Breeching Section

The breeching section 30 is the fourth section of the apparatus 10. The breeching section 30 is downstream of and in communication with the quench section 28. The breaching section 30 can abut and connect to the quench zone 28, for example, by flanges and bolts, to form a contiguous section for process flows. The breaching section 30 is designed to provide effective residence times for effective quench water droplet evaporation (or other quench material 34). “Typical” residence times in the breaching section 30 are, for example, about 0.3 to about 0.8 seconds.

The geometry of the breeching section 30 is any which will physically support the section and be conducive to the purposes of the section 30. The section 30 can be essentially cylindrical, and, generally, a pipe or cylindrical shape is the geometry that will be used in practice. The dimensions of this section 30 are designed such that the desired residence time, velocity to keep carbon black suspended in the gas stream, and pressure drop are achieved. The dimensions are also designed to evaporate the water (quench material 34) droplets in the process stream prior to the stream reaching the heat exchanger, or other downstream processing equipment. One specific example of dimensions of the section 30 is an inner diameter of about 20″ to about 40″ and a length of about 72½ feet. The breaching section 30 can, for example, be designed such that additional cooling water (or quench material 34) can be added to bring the process stream(s) to a desired heat exchanger inlet temperature and to allow for, e.g., about 0.3 to about 0.8 seconds, residence time to give adequate water evaporation time. One of skill in the art would be able to determine the specific geometry and dimensions appropriate for the flow rates, residence times, etc. desired in a particular embodiment according to standard design processes. Such a standard design process includes using a “design case” to determine residence time, pressure drop, etc.

The breaching section 30 comprises a material which can withstand the temperatures reached by the process streams exiting the quench section 28. This temperature can be up to about 3800° F., but will generally be significantly lower. This material can comprise, for example, a refractory material or a metallic material, such as high alumina hot face refractory or a lower temperature refractory material. The section 30 can comprise layers of various materials. One of skill in the art would be able to determine the types of material appropriate for the conditions expected within the breaching section 30 of the reactor 10 according to process, economic, and safety considerations, for example.

The breeching section 30 is the section which delivers the reacted gas and carbon black stream to a process air heat exchanger, or other downstream process or apparatus.

This section 30 is designed to operate at effective velocities to move essentially all carbon black without deposit out of the section 30 and to provide effective residence times for effective quench water 34 droplet evaporation prior to any downstream process or apparatus. One of skill in the art would be able to determine the desired velocity and residence time for this section 30 according to standard design processes. For example, there are various guidelines developed by one of skill in the art through experience with reactors so as to not damage heat exchange equipment or affect operation. For example, economic considerations affect determination of the design of this section 30.

The four sections described above need not be physically separate or distinct components, but may be different functional areas within a single formed component.

Different ways of forming and/or connecting the sections are known in the art.

The reactor 10 can comprise additional sections, but the above sections would remain in their same order relative to each other from upstream to downstream.

The reaction time is measured from the inlet 18, 24 of the feedstock 20 to the point at which the reaction is essentially stopped by quenching.

To determine or vary the characteristics of the product, the amounts of oxidant 16, fuel 16, and carbonaceous feedstock 20 can be varied.

### Simplified Plant

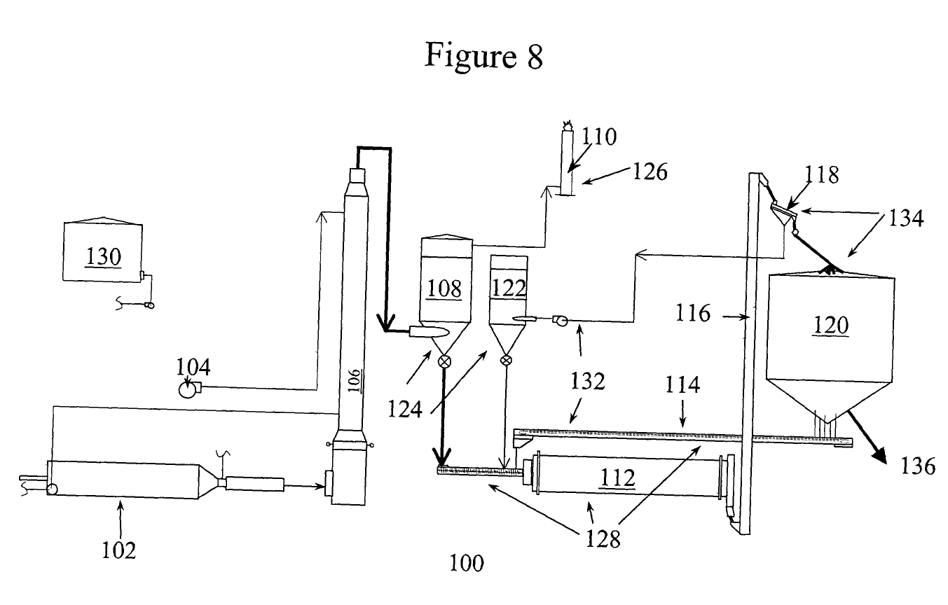

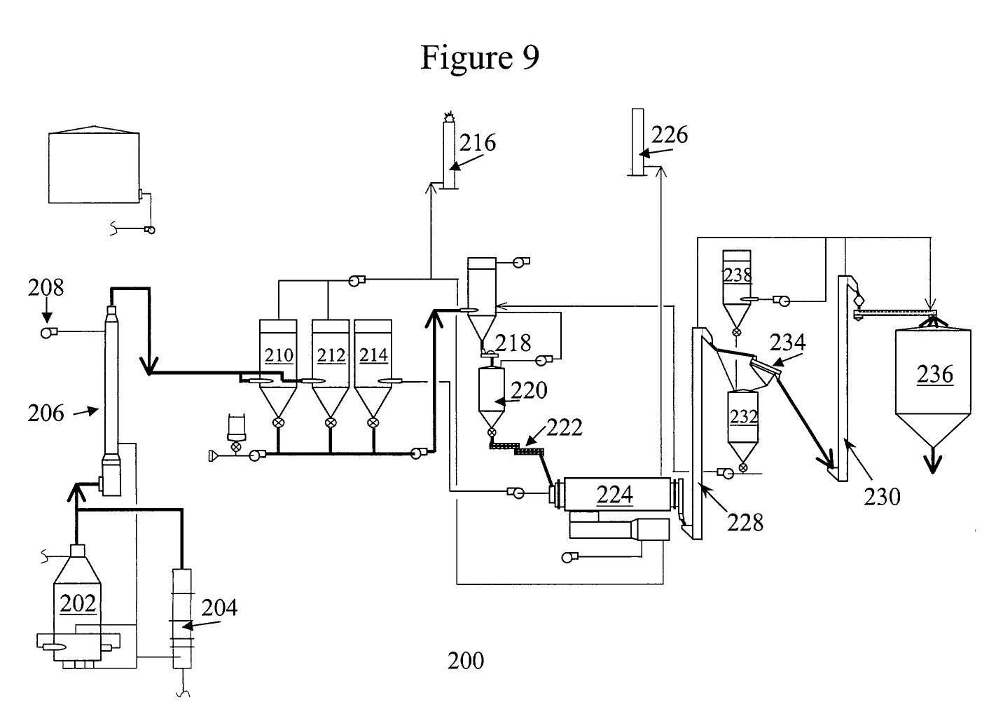

The invention also comprises a simplified plant system 100 for producing carbon black (illustrated schematically, e.g., FIG. 8). This system 100 has a significantly reduced number of components relative to a conventional process (illustrated schematically e.g., FIG. 9) for producing carbon black.

The system 100 and process comprise a simplified, unique process that utilizes a single reactor 102 to produce tread and/or carcass type carbon blacks without interruption, such as physically changing reactor sections or switching to a different reactor 202, 204 (requiring additional equipment) which typically would take significantly longer time than to change grade types by changing oil spray nozzles and/or positions and/or operating rates as would be required if only a single reactor 102 is used. The system 100 layout is unique in that it is arranged in a compact layout utilizing, for example, gravity or pneumatic conveying and elimination of various equipment. In the specific embodiments illustrated in FIGS. 8 and 9, the components are reduced from 40 in the conventional system 200 to 23 in the system 100 of the present system, almost a 50% reduction. See Table 1.

TABLE 1
Comparative Equipment List

| | Conventional (FIG. 9) | Simplified plant (FIG. 8) |
|---|---|---|
| Reactor | 1 carcass reactor 202 | 1 combination reactor 102 |
| area | 1 tread reactor 204 | |
| | 1 process air blower 208 | 1 process air blower 104 |
| | 1 heat exchanger 206 | 1 heat exchanger 106 |
| Collection | 2 pulse jet modules-primary | 1 pulse jet module-primary |
| area | bag filters 210, 212 | bag filter 108 |
| | 1 vapor bag collector pulse jet | |
| | module 214 | |
| | 3 rotary valves | 1 rotary valve |
| | 1 tail gas flare stack 216 | 1 tail gas flare stack 110 |
| Conveying | 1 pneumatic air piping system | |
| system | 3 air conveying fans | |
| | 1 pulse jet conveying collector | |
| | 1 micropulverizer 218 | |
| Beading | 1 dense tank 220 | |
| and drying | 1 dense tank vent fan | |
| system | 1 double pass wet bead mixer | 1 dry bead drum 112 |
| | 222 | |
| | 1 rotary dryer 224 | |
| | 1 tail gas combustor | |
| | 1 tail gas conveying fan | |
| | 1 dryer combustion air fan | |
| | 1 dryer vapor fan | |
| | 1 dryer combustion gas stack | 1 recycle belt conveyor 114 |
| | 226 | 1 screw conveyor |
| Backend | 2 bucket elevators 228, 230 | 1 bucket elevator 116 |
| handling | 1 belt conveyor | |
| system | 1 non-standard tank 232 | |
| | 1 product screen 234 | 1 product screen 118 |
| | 1 rare earth magnet system | 1 rare earth magnet system |
| | 1 product tank 236 | 1 product tank 120 |
| | 1 rotary valve | 5 rotary valves |
| Packaging | 1 vent pulse jet collector 238 | 1 vent pulse jet collector 122 |
| and | 2 vent system conveying fans | 1 vent system conveying fan |
| venting | 1 supersack packaging system | 1 supersack packaging system |
| system | 1 semi automatic bag | 1 semi automatic bag |
| | packaging station | packaging station |
| | Truck bulk loading stations | Truck bulk loading stations |
| Total | 40 | 23 |
| compo- | | |
| nents | | |

The invention can be a system 100 for producing tread and/or carcass type carbon black comprising

a) a combination tread/carcass carbon black reactor 102,

b) a heat exchanger 106, and

c) a carbon black beading system 128.

The reactor 102 can be upstream of and in communication with the heat exchanger 106 which can be upstream of and in communication with the carbon black beading system 128.

The system 100 can further comprise a collection system 124, a gas disposal/treating system 126, carbonaceous feedstock storage area 130, recycle conveying system 132, a carbon black screening system 134, and/or a carbon black storage area 136. Other components or unit operations that can be added to the system would be apparent to one of skill in the art.

The combination tread/carcass carbon black reactor 102 can be the reactor of the present invention 10 or can be another single carbon black reactor able to produce tread and/or carcass carbon black, as desired. The combination tread/carcass carbon black reactor 10 of the present invention is described in detail above. Examples of other single carbon black reactors are described above in the BACKGROUND.

The carbonaceous feedstock storage area 130, heat exchanger 106, collection system 124, gas disposal/treating system 126, carbon black beading system 128, recycle conveying system 132, a carbon black screening system 134, and/or a carbon black storage area 136 are conventional unit operations apparatuses known in the art; Many, if not all, of these components can be commercially purchased “off-the shelf.”

The collection system 124 of the simplified system 100 can comprise a bag collector 108 and a vent collector 122.

The carbon black beading system 128 can be a dry beading system 112.

The conventional unit operations are designed (size, material, etc.) according to conventional engineering design processes as known in the art. As schematically illustrated, the known components are in communication with one another as known to one skilled in the art.

### Method

The present invention also provides a method for producing carbon black.

The invention can be a method for producing tread and/or carcass type carbon black in a single reactor comprising

a) providing a reactor comprising, in open communication and in the following order from upstream to downstream,

i) a combination combustion/reaction section, wherein the combustion/reaction section comprises at least one inlet for introducing a combustion feed therein and at least one inlet for introducing a carbonaceous feedstock therein,

ii) a choke section, wherein the choke section comprises at least one inlet, separate from the combustion/reaction section inlets, for introducing a carbonaceous feedstock therein and wherein the choke section converges toward a downstream end,

iii) a quench section, wherein the quench section comprises at least one inlet, separate from the combustion/reaction section and choke section inlets, for introducing a quench material therein, and

iv) a breeching section;

b) combusting combustion feed in the combustion/reaction section to form a stream of combustion gas flowing downstream through the reactor;

c) introducing a carbonaceous feedstock; and

d) maintaining process conditions in the reactor to convert the feedstock to carbon black with desired characteristics,

wherein the carbonaceous feedstock is introduced into the combustion/reaction section of the reactor when producing a carcass type carbon black product, and

wherein the carbonaceous feedstock is introduced into the choke section of the reactor when producing a tread type carbon black product.

The reactor of the method can be, for example, the reactor 10 described above in the APPARATUS section.

The combustion feed (e.g., fuel and oxidant) is described above in the APPARATUS section. The fuel can be a hydrocarbon fuel, for example, natural gas. The oxidant can be, for example, pre-heated air.

The fuel and oxidant can be introduced to the reactor in various ways, for example, those described above in the APPARATUS section. One example is the fuel and oxidant can be introduced tangentially, relative to the circumference of the combustion/reaction section, into the reactor. The combustion fuel and oxidant can be introduced through multiple entries in the combustion/reaction section of the reactor.

The choice of combustion conditions and locations can be determined by one of skill in the art using known conventional design techniques.

The carbonaceous feedstock is described above in the APPARATUS section. The carbonaceous feedstock can be introduced to the reactor in various ways, for example, those described above in the APPARATUS section. The carbonaceous feedstock can be introduced, for example, through a central injection spray into the combustion/reaction section. The carbonaceous feedstock can be injected into high velocity combustion gas. It is desirable that the carbonaceous feedstock be atomized. The carbonaceous feedstock can be, for example, oil.

The carbonaceous feedstock can be introduced to the combustion/reaction section. The feedstock can be introduced so that it has a residence time and velocity which produces carcass type carbon black.

The carbonaceous feedstock can be introduced into the choke section. The carbonaceous feedstock can, for example, be radially introduced into the choke section. The radial introduction can be by multiple nozzles around the circumference of the choke section.

One of skill in the art can determine the process conditions of the method using known conventional engineering design processes.

The process conditions can comprise essentially stopping the reaction at a desired time via quenching. The quenching can be used to control overall reaction times of the tread and/or carcass type carbon blacks being produced. The quenching can be via introduction of water, for example, in the quench section of the reactor.

The process conditions can comprise operating the breeching section at effective velocities to move substantially all produced carbon black without deposition of carbon black in the breeching section. The process conditions can comprise operating the breeching section at an effective residence time for effective quench water evaporation/vaporization prior to exiting the breaching section.

The method can further comprise delivering reacted gas and produced carbon black to a process air heat exchanger, or other downstream processes or apparatuses.

The method can produce tread type and carcass type carbon black, for example, individually, sequentially, or simultaneously.

The invention can also be a method for producing tread and/or carcass type carbon black ready for packaging or distribution or use comprising

a) introducing fuel, oxidant, and a carbonaceous feedstock into a combination tread/carcass reactor to produce a carbon black product,

b) passing the carbon black product and any combustion and/or reaction gas through a heat exchanger to cool the product and gas,

c) introducing the cooled product and cooled combustion and/or reaction gas to a primary collection system,

d) disposing of or treating the cooled combustion/reaction gas,

e) feeding the collected product to a beading system,

f) moving the beaded product to a product screen to sort the product by size, and

g) allowing the sorted product to flow to a storage area.

The introduction of fuel, oxidant, and a carbonaceous feedstock into a combination tread/carcass reactor to produce a carbon black product can be accomplished, for example, by the method and apparatus described above.

Passing of the carbon black product and any combustion and/or reaction gases through a heat exchanger can be accomplished by any transport method, for example, by a blower. One of skill in the art would be able to determine appropriate mass transport considerations for designing this step.

Introduction of the cooled product and cooled combustion and/or reaction gases to a primary collection system can be, for example, by pressure differential, i.e., pneumatic conveying and entrainment. The primary collection system can be, for example, a bag collector. One of skill in the art would be able to determine appropriate mass transport considerations for designing this step as well as appropriate equipment for primary collection.

The primary collection system can be used for separation of the solid product and the gases.

Disposal of or treatment of the cooled combustion/reaction gases is the next step of this method. The disposal or treatment of the cooled combustion/reaction gases can be by a tail gas flare. One of skill in the art would be able to determine appropriate mass transport and environmental considerations for designing this step as well as appropriate equipment for disposal or treatment.

A further step in the method can be feeding the collected product to a beading system. The beading system can be a dry beading system, for example. The feeding can be, for example, gravity feeding. One of skill in the art would be able to determine appropriate mass transport considerations for designing this step as well as appropriate equipment for feeding and beading.

An additional step is movement of the beaded product to a product screen to sort the product by size. One of skill in the art would be able to determine appropriate mass transport considerations for designing this step as well as appropriate equipment for movement and screening.

Another step is allowing the sorted product to flow to a storage area. One of skill in the art would be able to determine appropriate mass transport considerations for designing this step as well as appropriate equipment for movement and storage.

Recycling oversize and/or undersize product from the product screen to the beading system can be an additional step. One of skill in the art would be able to determine appropriate mass transport considerations for designing this step as well as appropriate equipment for movement of the product.

The recycling step is usually limited to a plant which uses a dry beading system.

Movement of the dust from the product screen, and optionally from venting of other equipment (such as elevators, belt conveyors, product tanks), to a secondary collection system can be a step in the process. The secondary collection system can be, for example, a bag collector. One of skill in the art would be able to determine appropriate mass transport considerations for designing this step as well as appropriate equipment for movement and collection.

A further step can be allowing any dust collected in the secondary collection system to flow to the beading system. One of skill in the art would be able to determine appropriate mass transport considerations for designing this step as well as appropriate equipment for movement.

The method can further comprise utilizing heat from the heat exchanger to pre-heat the fuel and/or oxidant introduced to the combination tread/carcass reactor. Utilization of the heat can be determined by one of skill in the art according to standard heat transfer design procedures.

The method can further comprise packaging the product. The method can further comprise distributing the product in bulk containers, moving the product to a carbon black storage or feed area of a facility that uses carbon black in an end use application. For example, the facility that uses carbon black in an end use application can be a tire plant. The facility that uses carbon black in an end use application can be adjacent to the carbon black production facility. One of skill in the art would be able to determine appropriate design considerations for designing this step as well as appropriate equipment for moving and/or packaging the product.

### EXAMPLES

The following examples are put forth so as to provide those of ordinary skill in the art with a complete disclosure and description of how the compounds, compositions, articles, devices, and/or methods claimed herein are made and evaluated, and are intended to be purely exemplary of the invention and are not intended to limit the scope of what the inventors regard as their invention. Efforts have been made to ensure accuracy with respect to numbers (e.g., amounts, temperature, etc.) but some errors and deviations should be accounted for. Unless indicated otherwise, parts are parts by weight, temperature is in ° F. or is at ambient temperature, and pressure is at or near atmospheric.

### Example 1

### Calculated Data

Various reactors were compared by typical values using actual known operating values. The invention values in the table were calculated using design equations. The air rate was set for throughput of an arbitrary 35 metric tons/day target production value.

TABLE 2
Reactor Comparisons.

| | Typical Operating Values | | | | | |
|---|---|---|---|---|---|---|
| | Carcass Operation | | | | Tread Operation | |
| | | | Invention | Standard | | Invention |
| Reactor Type | Plant 1 | Plant 2 | (FIG. 7) | (FIG. 2) | | (FIG. 7) |
| C/R Section | 48.1 | 63.2 | 54.9 | 37.7 | 222 | 108.8 |
| Longitudinal Linear | | | | | | |
| Velocity | | | | | | |
| (ft./sec) | | | | | | |
| Choke Section Throat | 244 | 244 | 679* | 84 | 1533 | 1209 |
| Velocity | | | | | | |
| (ft./sec) | | | | | | |
| Residence Time to Oil | | | | | 0.016 | 0.193 |
| Spray | | | | | | |
| (sec) | | | | | | |
| Residence/Reaction | 0.31- | 0.17- | 0.42-0.55 | 1.5-1.6 | 0.024 | 0.025 |
| Time to Quench | 0.45 | 0.36 | | | | |
| (sec) | | | | | | |
| Breeching Section | 0.12 | 0.31 | 0.54 | 0.44 | 0.57 | 0.37 |
| Residence Time to | | | | | | |
| Heat Exchanger | | | | | | |
| (sec) | | | | | | |
| Breeching Section | 294 | 106 | 80 | 104-130 | 74.8 | 128 |
| Velocity | | | | | | |
| (ft./sec) | | | | | | |

*These values should be non-critical for carcass operation as carbon black formation will be essentially complete before reaching converging section.

Throughout this application, various publications are referenced. The disclosures of these publications in their entireties are hereby incorporated by reference into this application in order to more fully describe the state of the art to which this invention pertains.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A reactor for producing carbon black comprising, in open communication and in the following order from upstream to downstream,
a) a combination combustion/reaction section, wherein the combustion/reaction section comprises at least one inlet for introducing a combustion feed therein and at least one inlet for introducing a carbonaceous feedstock therein;
b) a choke section, wherein the choke section comprises at least one inlet, separate from the combustion/reaction section inlets, for introducing a carbonaceous feedstock therein and wherein the choke section converges toward a downstream end;
c) a quench section, wherein the quench section comprises at least one inlet, separate from the combustion/reaction section and choke section inlets, for introducing a quench material therein; and
d) a breeching section.

2. The reactor of claim 1 wherein the cross section of the quench section is equal to or larger than the downstream end of the choke section and smaller than the cross section of the combustion/reaction section.

3. The reactor of claim 1 wherein each section is proximally located to the section upstream and the section downstream.

4. The reactor of claim 1 wherein the combustion/reaction section inlet for introduction of combustion feed is designed for substantially tangential introduction of combustion feed relative to the circumference of the combustion/reaction section.

5. The reactor of claim 1 wherein the combustion/reaction section inlet for introduction of combustion feed is designed for substantially axial introduction of combustion feed relative to the circumference of the combustion/reaction section.

6. The reactor of claim 1 wherein the combustion/reaction section inlet for introduction of carbonaceous feedstock is designed for substantially longitudinal introduction of the carbonaceous feedstock relative to the centerline of the combustion/reaction section.

7. The reactor of claim 1 wherein the choke section inlet for introduction of carbonaceous feedstock is designed for substantially radial introduction of feedstock.

8. The reactor of claim 1 wherein the combustion/reaction section comprises a material capable of withstanding temperatures of about 3800° F.

9. The reactor of claim 1 wherein the combustion/reaction section comprises refractory.

10. The reactor of claim 9 wherein the refractory is high alumina hot face refractory.

11. The reactor of claim 1 wherein the combustion/reaction section comprises a substantially cylindrical shape.

12. The reactor of claim 4 wherein the combustion/reaction section inlet is designed to create multiple swirls of the introduced combustion feed.

13. The reactor of claim 1 wherein the combustion/reaction section combustion feed inlet is designed for introduction of pre-heated process air and hydrocarbon fuel.

14. The reactor of claim 1 wherein the combustion/reaction section combustion feed inlet is designed for introduction of pre-heated process air and natural gas fuel.

15. The reactor of claim 1 wherein the combustion/reaction section is designed for an effective residence time and an effective velocity which support carcass type carbon black production.

16. The reactor of claim 1 wherein the combustion/reaction section is designed for combustion residence times approximately two to six times longer than conventional tread reactors.

17. The reactor of claim 1 wherein the choke section is designed for higher velocities than a conventional reactor, which supports carcass type carbon black production.

18. The reactor of claim 1 wherein the at least one inlet of the choke section comprises multiple nozzles placed radially around the internal circumference of the choke section designed to support tread type carbon black production.

19. The reactor of claim 1 wherein the quench section is designed to control overall reaction times of tread and/or carcass type carbon blacks to be produced in the reactor.

20. The reactor of claim 1 wherein the at least one inlet of the quench section is multiple quench inlets.

21. The reactor of claim 1 wherein the quench section is designed for reaction times of about 80% to about 150% of conventional tread reactors.

22. The reactor of claim 1 wherein the quench section is designed for velocities of about 50% to about 150% of conventional tread reactors.

23. The reactor of claim 1 wherein the breeching section comprises refractory.

24. The reactor of claim 1 wherein the breeching section is designed to operate at effective velocities to move substantially all produced carbon black without deposition of carbon black in the breeching section.

25. The reactor of claim 1 wherein the breeching section is designed to provide effective residence times for quench water droplet evaporation.

26. A system for producing tread and/or carcass type carbon black comprising
a) a combination tread/carcass carbon black reactor upstream of and in communication with
b) a heat exchanger upstream of and in communication with
c) a carbon black beading system.

27. The system of claim 26 further comprising a collection system.

28. The system of claim 26 further comprising a gas disposal system.

29. The system of claim 26 further comprising a carbon black screening system.

30. The system of claim 26 further comprising a recycle conveying system.

31. The system of claim 26 further comprising a carbon black storage area.

32. The system of claim 27 wherein the collection system comprises a bag collector and a vent collector.

33. The system of claim 26 wherein the carbon black beading system is a dry beading system.

34. The system of claim 26 further comprising a carbonaceous feedstock storage area.

35. The system of claim 26 wherein the combination tread/carcass carbon black reactor is the reactor of claim 1.

36. A system for producing tread and/or carcass type carbon black consisting essentially of
a) a combination tread/carcass carbon black reactor,
b) a heat exchanger,
c) a collection system,
d) a gas disposal system,
e) a carbon black beading system,
f) a recycle conveying system, and
g) a carbon black screening system.

37. A system for producing tread and/or carcass type carbon black consisting of
a) a combination tread/carcass carbon black reactor,
b) a heat exchanger,
c) a collection system,
d) a gas disposal system,
e) a carbon black beading system,
f) a recycle conveying system, and
g) a carbon black screening system.

38. A method for producing tread and/or carcass type carbon black in a single reactor comprising
a) providing a reactor comprising, in open communication and in the following order from upstream to downstream,
i) a combination combustion/reaction section, wherein the combustion/reaction section comprises at least one inlet for introducing a combustion feed therein and at least one inlet for introducing a carbonaceous feedstock therein,
ii) a choke section, wherein the choke section comprises at least one inlet, separate from the combustion/reaction section inlets, for introducing a carbonaceous feedstock therein and wherein the choke section converges toward a downstream end,
iii) a quench section, wherein the quench section comprises at least one inlet, separate from the combustion/reaction section and choke section inlets, for introducing a quench material therein, and
iv) a breeching section;
b) combusting combustion feed in the combustion/reaction section to form a stream of combustion gas flowing downstream through the reactor;
c) introducing a carbonaceous feedstock into the reactor; and
d) maintaining process conditions in the reactor to convert the feedstock to carbon black with desired characteristics,
wherein the carbonaceous feedstock is introduced into the combustion/reaction section of the reactor when producing a carcass type carbon black product, and
wherein the carbonaceous feedstock is introduced into the choke section of the reactor when producing a tread type carbon black product.

39. The method of claim 38 wherein the carbonaceous feedstock is introduced into the combustion/reaction section of the reactor when producing a carcass type carbon black product.

40. The method of claim 38 wherein the carbonaceous feedstock is introduced into the choke section of the reactor when producing a tread type carbon black product.

41. The method of claim 38 wherein the combustion feed comprises a fuel and an oxidant.

42. The method of claim 41 wherein the combustion fuel is a hydrocarbon fuel.

43. The method of claim 41 wherein the combustion fuel is natural gas.

44. The method of claim 41 wherein the combustion oxidant is pre-heated air.

45. The method of claim 41 wherein the combustion fuel and oxidant are introduced tangentially, relative to the circumference of the combustion/reaction section, into the reactor.

46. The method of claim 41 wherein the combustion fuel and oxidant are introduced through multiple entries in the combustion/reaction section of the reactor.

47. The method of claim 38 wherein the carbonaceous feedstock is introduced through a central injection spray into the combustion/reaction section.

48. The method of claim 38 wherein the carbonaceous feedstock is introduced longitudinally into the combustion/reaction section of the reactor when producing a carcass type carbon black product.

49. The method of claim 38 wherein the carbonaceous feedstock is introduced radially into the choke section of the reactor when producing a tread type carbon black product.

50. The method of claim 38 wherein the carbonaceous feedstock is atomized.

51. The method of claim 38 wherein the carbonaceous feedstock is oil.

52. The method of claim 38 wherein the carbonaceous feedstock is introduced to the combustion/reaction section and wherein the introduced feedstock has a residence time and a velocity which produces carcass type carbon black.

53. The method of claim 38 wherein the carbonaceous feedstock is introduced into the choke section.

54. The method of claim 38 wherein the carbonaceous feedstock is radially introduced into the choke section.

55. The method of claim 54 wherein the radial introduction is by multiple nozzles around the circumference of the choke section.

56. The method of claim 38 wherein the carbonaceous feedstock is injected into high velocity combustion gas.

57. The method of claim 38 wherein the process conditions comprise essentially stopping the reaction at a desired time via quenching.

58. The method of claim 57 wherein the quenching is used to control overall reaction times of the tread and/or carcass type carbon black being produced.

59. The method of claim 57 wherein the quenching is via introduction of water in the quench section of the reactor.

60. The method of claim 38 wherein the process conditions comprise operating the breaching section at effective velocities to move substantially all produced carbon black without deposition of carbon black in the breeching section.

61. The method of claim 38 wherein the process conditions comprise operating the breaching section at an effective residence time for quench water vaporization prior to exiting the breaching section.

62. The method of claim 38 further comprising delivering reacted gas and produced carbon black to a process air heat exchanger.

63. The method of claim 38 wherein tread type and carcass type carbon black may be produced individually, sequentially, or simultaneously.

64. A method for producing tread and/or carcass type carbon black ready for packaging or distribution or use comprising
a) introducing fuel, oxidant, and a carbonaceous feedstock into a combination tread/carcass reactor to produce a carbon black product,
b) passing the carbon black product and any combustion and/or reaction gas through a heat exchanger to cool the product and gas,
c) introducing the cooled product and cooled combustion and/or reaction gas to a primary collection system,
d) disposing of or treating the cooled combustion/reaction gas,
e) feeding the collected product from the primary collection system to a beading system,
f) moving the beaded product to a product screen to sort the product by size, and
g) allowing the sorted product to flow to a storage area.

65. The method of claim 64 further comprising recycling any oversize and/or undersize product to the beading system.

66. The method of claim 64 further comprising moving dust from the product screen to a secondary collection system.

67. The method of claim 64 further comprising allowing any dust collected in the secondary collection system to flow to the beading system.

68. The method of claim 64 wherein the primary collection system is a bag collector.

69. The method of claim 64 wherein the beading system is a dry beading system.

70. The method of claim 64 wherein the feeding is gravity feeding.

71. The method of claim 64 wherein the secondary collection system is a bag collector.

72. The method of claim 64 wherein the combination tread/carcass reactor is the reactor of claim 1.

73. The method of claim 64 further comprising utilizing heat from the heat exchanger to pre-heat the fuel and/or oxidant introduced to the combination tread/carcass reactor.

74. The method of claim 64 wherein the disposal or treatment of the cooled combustion/reaction gas is by a tail gas flare.

75. The method of claim 64 further comprising packaging the product.

76. The method of claim 64 further comprising distributing the product in bulk containers.

77. The method of claim 64 further comprising moving the product to the carbon black storage or feed area of a facility that uses carbon black in an end use application.

78. The method of claim 77 wherein the facility that uses carbon black in an end use application is a tire plant.

79. The method of claim 77 wherein the facility that uses carbon black in an end use application is adjacent to the carbon black production facility.
